(19) United States
(12) Patent Application Publication
(10) Pub. No.: US 2010/0055330 A1
(43) Pub. Date: Mar. 4, 2010

(54) Epitaxy Processing System and Its Processing Method

(75) Inventors: Tsan-Hua Huang, Tainan City (TW); Benson Chao, Hsinchu (TW)

Correspondence Address: ROSENBERG, KLEIN & LEE, 3458 ELLICOTT CENTER DRIVE-SUITE 101, ELLICOTT CITY, MD, 21043, US

(73) Assignee: Hermes Systems Inc., Hsinchu (TW)

(21) Appl. No.: 12/199,938

(22) Filed: Aug. 28, 2008

(51) Int. Cl. B05C 11/00; B05D 3/00

(52) U.S. Cl. 427/299; 118/69

(57) ABSTRACT

An epitaxy processing system and its processing method for enhancing operation efficiency is provided. The system includes a stacked cassette, a transportation device, a reaction chamber, and a cooling device. The cooling device can rapidly cool down susceptor and processed wafers without damaging the epitaxy layer. The cluster system design minimizes the footprint of system, reduces the operation cost, and increases throughput and thereby enhances the productivity of the system.

### BACKGROUND OF THE INVENTION

1. Field of the Invention

The present invention relates to the field of wafer processing system. More particularly, the present invention relates to an epitaxy processing system and its processing method which comprises a transportation device which can move the susceptor out from high temperature reacting chamber to a cooling device which afterward can rapidly cool down the wafers and the susceptor to increase the production capacity.

2. Description of the Prior Art

In the fabrication of integrated circuit and compound semiconductor, processing system is generally employed to process semiconductor wafers. Those processing system include a reacting chamber to effectuate depositions, epitaxy, etching, and so on.

The conventional processing system includes a glove box with a loadlock and a reacting chamber arranged inside the glove box. When a fabrication process is going to proceed, the operator must first put the wafer boat into the glove box via the loadlock, followed by pick and place the wafers onto the susceptor which locates in the reacting chamber by manual operation, then close the reacting chamber lid and the epitaxy process is starting to proceed. After process ends, the susceptor with wafers will not move out of the reacting chamber immediately until the nitrogen gas cycle purge inside the reacting chamber and reacting chamber temperature lower down to 150° C. However, this step occupies lots of machine time to process next one cycle and consumes lots of nitrogen gas.

### SUMMARY OF THE INVENTION

The present invention generally provides a wafer processing system and its processing method including a reacting chamber, a transportation device which provides the susceptor transportation and a cooling device which provides a quickly temperature-lowering down function and a volume minimized stacked cassette as a loadlock function.

A volume minimized stacked cassette containing a plurality of susceptors, wherein each susceptor has at least a wafer placed thereon. A transportation device is utilized for transmitting those susceptors between the reacting chamber, the cooling device, and the stacked cassette. At process initial, the transportation device transmits the susceptor in stacked cassette through a chamber gate valve to reacting chamber which maintain at high temperature environment. After process ends, the transportation device transmits the susceptor from high temperature reacting chamber to cooling device for quickly cooling down. Wherein the transportation device follows up transmits another susceptor in stacked cassette to the reacting chamber for next one run processing. After that, the cooled down susceptor on the cooling device is transmitting to the stacked cassette.

In one embodiment of the present invention, an epitaxy processing system including: a stacked cassette for containing a plurality of susceptors, wherein each of the susceptors has at least a wafer placed thereon; a transportation device for transporting the susceptors; a reacting chamber having a chamber gate valve, wherein the susceptor is transported by the transportation device from the stacked cassette through the chamber gate valve and the wafer is processed while the chamber gate valve is closed; and a cooling device for cooling the processed wafer transported by the transportation device from the reacting chamber under a high temperature, and the processed wafer is cooled down to a lower temperature. After transporting the processed wafer into the cooling device, the transportation device transports another susceptor from the staked cassette into the reacting chamber for next one run processing.

In another embodiment of the present invention, an epitaxy processing system is provided. The epitaxy processing system includes a stacked cassette for containing a plurality of susceptors, wherein each of those susceptor has at least a wafer placed thereon. A transportation device is utilized for transmitting those susceptors. A plurality of reacting chambers are arranged around the transportation device, each of the reacting chambers having a chamber gate valve, wherein the susceptors are respectively transported by the transportation device from the stacked cassette to those reacting chambers; and for each of those reacting chambers, the susceptor is transported while the chamber gate valve is open, and the wafer is processed while the chamber gate valve is closed. And, a cooling device is utilized for sequentially cooling the processed wafers transported by the transportation device respectively from those reacting chambers under a high temperature, and the processed wafers are respectively cooled down to a lower temperature, wherein those cooled processed wafers are removed out the cooling device by the transportation device to load in the stacked cassette. Once one susceptor is removed out from one reacting chamber, another susceptor is transported from the stacked cassette to the empty reacting chamber by the transportation device.

In another embodiment of the present invention, an epitaxy processing method is provided. The epitaxy processing method including: providing a plurality of susceptors disposed in a stacked cassette, wherein each of the susceptors has at least a wafer placed thereon; transporting the susceptor by a transportation device from the stacked cassette into a reacting chamber having a chamber gate valve, the susceptor is transported while the chamber gate valve is open and the wafer is processed while the chamber gate valve is closed; transporting the processed wafer by the transportation device from the reacting chamber under a high temperature into a cooling device; cooling the processed wafer to a lower temperature by the cooling device; and after transporting the processed wafer into the cooling device, transporting another susceptor from the staked cassette into the reacting chamber by the transportation device for next run processing.

Other advantages of the present invention will become apparent from the following description taken in conjunction with the accompanying drawings wherein are set forth, by way of illustration and example, certain embodiments of the present invention.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

FIG. 1A is a schematic diagram showing an epitaxy processing system and its processing method in accordance with one embodiment of the present invention;

FIG. 1B is a schematic diagram showing an epitaxy processing system and its processing method in accordance with another embodiment of the present invention;

FIG. 2 is a schematic diagram showing a susceptor arranged on a cooling device in accordance with one embodiment of the present invention;

FIG 3A is a schematic diagram showing one embodiment of an epitaxy processing system and its processing method in accordance with one embodiment of the present invention;

FIG. 3B is a schematic diagram showing one embodiment of an epitaxy processing system and its processing method in accordance with one embodiment of the present invention; and

FIG. 4 is a schematic diagram showing another embodiment of an epitaxy processing system and its processing method in accordance with one embodiment of the present invention.

### DETAILED DESCRIPTION OF THE INVENTION

The present invention generally provides an epitaxy processing system and its processing method including a reacting chamber, a transportation device which provides the susceptor transportation and a cooling device which provides a quickly temperature-lowering function and a volume minimized stacked cassette as a loadlock function. The detailed explanation of the present invention is described as following. The described embodiments are presented for purposes of illustrations and description, and they are not intended to limit the scope of the present invention.

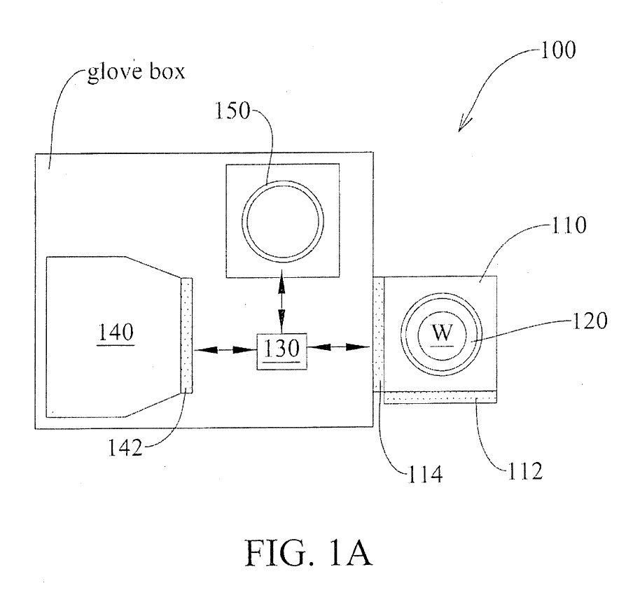

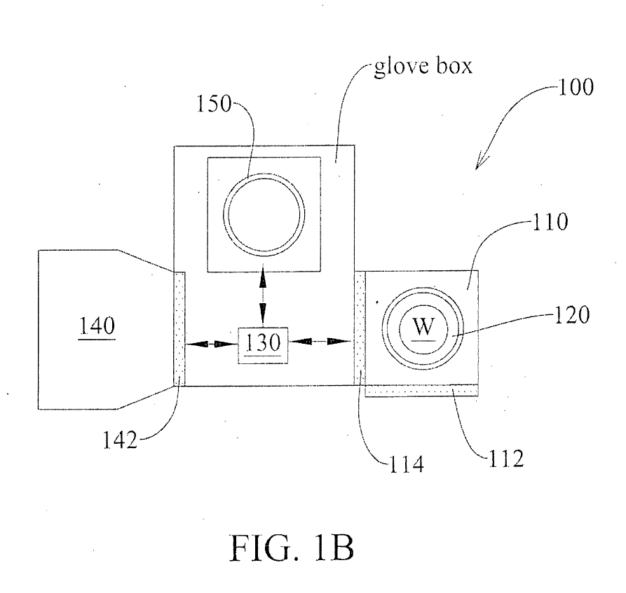

Firstly, refer to FIG 1A, FIG 1A shows a schematic diagram illustrating an epitaxy processing system and its processing method in accordance, with one embodiment of the present invention. As shown in the figure, the epitaxy processing system 100 of one embodiment of the present invention includes a stacked cassette 110, which is volume minimized, for containing a plurality of susceptors 120, wherein each susceptor 120 has at least a wafer W placed thereon. A transportation device 130 is utilized for transporting those susceptors 120, and one susceptor 120 is transported at a time. Those susceptors 120 are transported by the transportation device 130 from the stacked cassette 110 into a reacting chamber 140 and the wafer W is processed in the reacting chamber 140, wherein the reacting chamber 140 has a chamber gate valve 142 and the chamber gate valve 142 is open when the transportation device 130 carries the susceptor 120 into or out from the reacting chamber 140. And, a cooling device 150 is utilized for cooling the processed wafer W which is still in a high temperature, such as over 500° C. and transported by the transportation device 130 from the reacting chamber 140 after reacting, and then another susceptor 120 which has a un-processed wafer placed thereon is transmitted from the stacked cassette 110 to the reacting chamber 140 which remains substantially at the high temperature by the transportation device 130. The transportation device 130 can take out the susceptor 120 with the wafer W which are still in a high temperature from the reacting chamber 140 into the cooling device 150 immediately, and then the transportation device 130 can pick another susceptor with a wafer from the stacked cassette 110 into the reacting chamber 140 to react while the reacting chamber 140 is still in the high temperature so that the processing time can be reduced to improve the throughput. It is understood that the temperature may be slightly lower down when the gate valve 142 of the reacting chamber 140 is open. However, the effects of the invention may hot be affected.

Continuing the above description, in one embodiment, the transportation device 130, the cooling device 150 and the reacting chamber 140 are arranged in a closed space, which is called a glove box, and the glove box is cycle purged with an inert gas, such as the nitrogen gas, to lower down the concentration of oxygen in the glove box to a PPM level. The stacked cassette 110 is a closed space in the system and has two cassette gate valves; one of the cassette gate valves, such as cassette gate valve 112, is faced to an external atmospheric environment; and another, cassette gate valve 114 for example, is faced to the epitaxy processing system 100, and the stacked cassette 110 is cycle purged with the nitrogen gas also. In another embodiment, the stacked cassette 110 can have a two-directional susceptor picking structure and can be fixed or rotated. An operator can pick those wafers which are placed on the wafer boat onto the susceptor 120 in the working area in atmospheric environment, and then load these susceptors 120 into the stacked cassette 110 from cassette gate valve 112. Hereafter, stacked cassette 110 is purged with the nitrogen gas and those wafers W are transported into the reacting chamber 140 by the transportation device 130. In one embodiment, the transportation device 130 can has a robot or a linear slide guide to transfer the susceptor 120 and wafer W placed thereon, especially one susceptor 120 each time.

Continuously, in one embodiment, the reacting chamber 140 has a gas distribution apparatus that provides separate and uniform distribution of at least two gases and a fluid cooling pathway provided within the reacting chamber. In the gas distribution apparatus, a thin-plated susceptor made of high thermal conductivity, low thermal mass and high density material is provided to quick temperature ramp-up/down for processing equipment and automation handling. Referring to FIG. 1B, in another embodiment, the reacting chamber 140 also can be set outside the closed space. Therefore, the transportation device 130, the cooling device 150 and the chamber gate valve 142 are arranged in the closed space. Besides, the closed space, such as the glove box, and the stacked cassette are cycle purged with nitrogen gas. It is very convenient to the operator when the reacting chamber 140 needs to be maintained, the operator can just open the lid of the reacting chamber to check out.

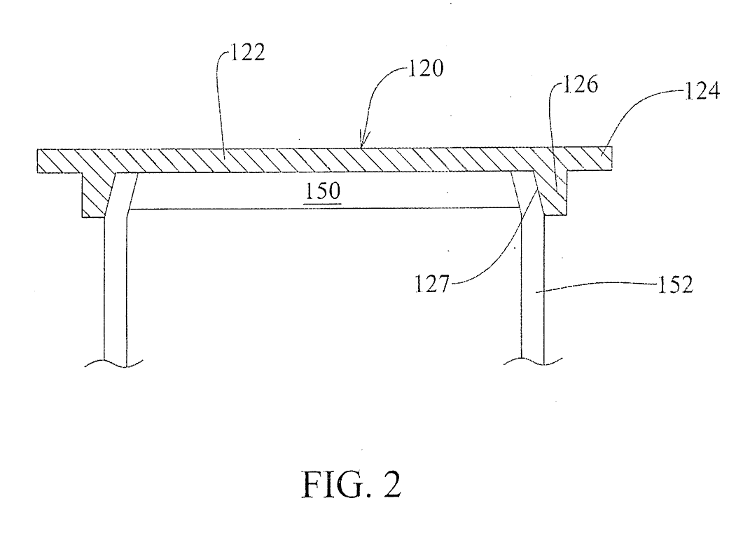

For easily transmitting those susceptors 120 and pick and place by the transportation device 130, the schematic diagram of the susceptor of the present invention is shown in FIG. 2. As shown in the figure, the susceptor 120 has a [symbol] -type profile, and the susceptor 120 includes a plate 122 to have at least a wafer W placed thereon; an ring-like flange 124, which is an peripherally extension of the plate 122, for detachably contact with the transportation device 130; and an encircled supporting wall 126 underneath the plate 122, the inner side 127 of the supporting wall 126 is beveled outwardly, the beveled edge is inclined so that there is an obtuse angle between the plate 122 and the inner side 127 of the supporting wall 126, in order to mount on a rotor 152 of the cooling device 150. In one embodiment, the transportation device 130 is utilized to hold the ring-like flange 124 of the susceptor 120 in a regular way or clip the outer lateral of the plate 122 of the susceptor 120 to move outward in changing the width of the transportation device 130. Continuously, in one embodiment, the cooling device 150 can utilize an upper gas sparging cooling method, a lower fluid pipe conduction cooling method or a superconductor medium contact cooling method to lower down the temperature of those susceptors and wafers. In one embodiment, the cooling device 150 is designed to control the cooling rate and the susceptors and wafers which are still in the high temperature can be cooled down gradually and immediately. Besides, because of the design of the cooling device 150, the nitrogen gas usage during the cooling can be reduced.

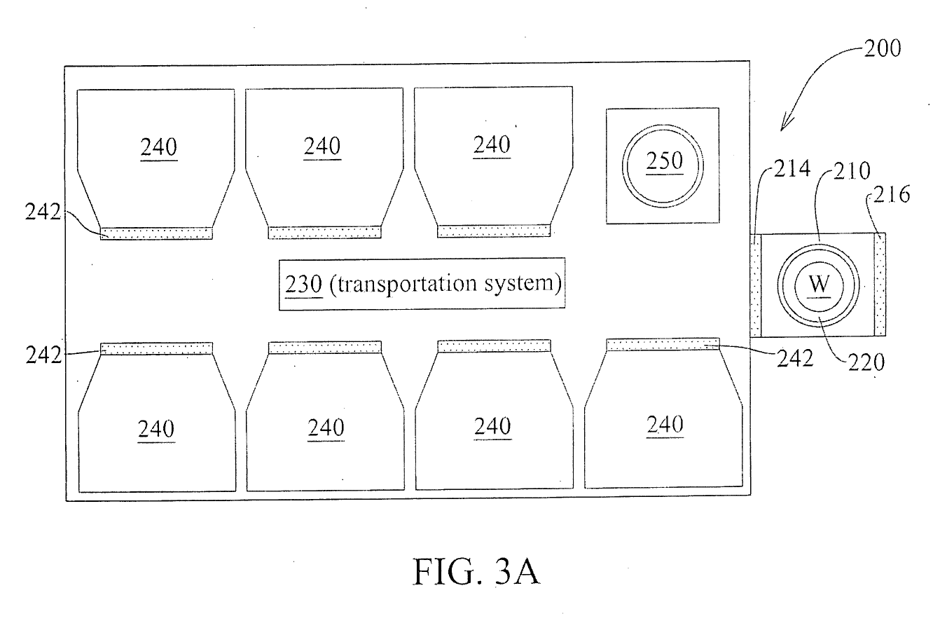

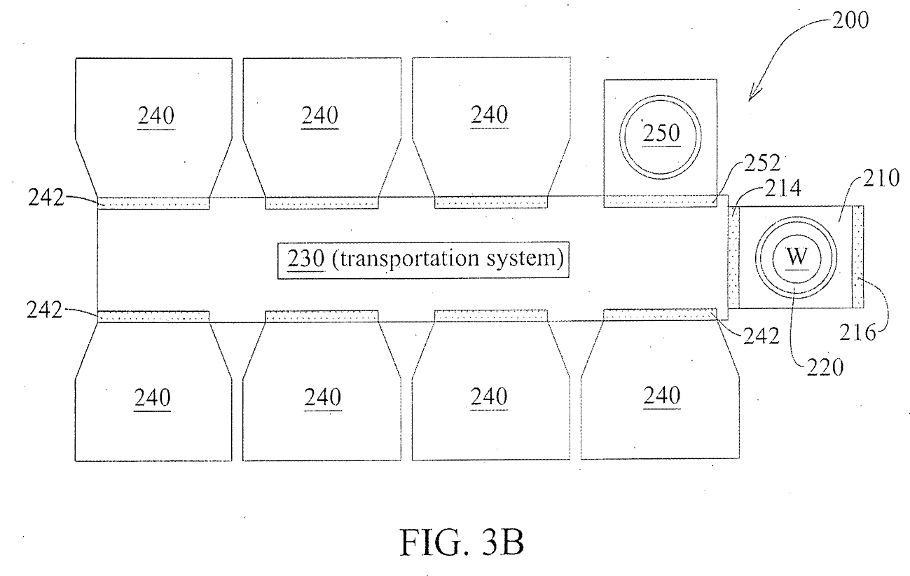

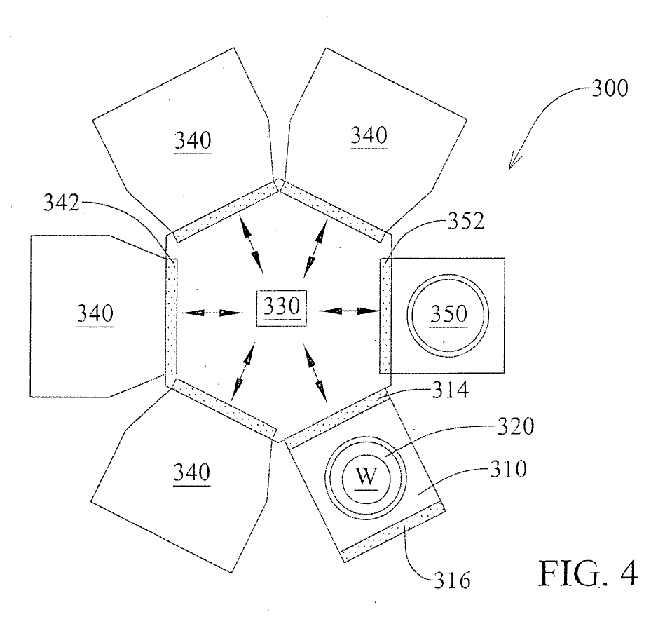

In another embodiment, a plurality of reacting chambers 240 can be applied in the epitaxy processing system 200, wherein the structure of the stacked cassette 210, the susceptor 220, the transportation device 230 and the cooling device 250 are approximately the same as last embodiment so that it is no unnecessary detailed here. The arrangement of the reacting chambers 240 and the cooling device 250 are described in the following. Please refer to FIG. 3A, a plurality of reacting chambers 240, each of the reacting chambers 240 having a chamber gate valve 242, wherein those susceptors 220 are respectively transported by the transportation device 230 from the stacked cassette 210 to the reacting chambers 240; for each of the reacting chambers 240, the susceptor 220 is transported while one of the chamber gate valve 242 is open and the wafer W are processed while the chamber gate valve 242 is closed; the reacting chambers 240 are arranged around the transportation device 230. And, a cooling device 250 is utilized for sequentially cooling those processed wafers W transported by the transportation device 230 respectively from those reacting chambers 240 under a high temperature, and the processed wafers W are cooled down to a lower temperature, wherein those cooled processed wafers W are removed out the cooling device 250 by the transportation device 230 to load in the stacked cassette 210, once susceptor 220 is removed out from those reacting chambers 240, another susceptor 220 is transported from the stacked cassette 210 to the empty reacting chamber 240 which is still in the high temperature by the transportation device 230 for next one run processing. FIG. 3A and FIG. 3B are an in-line type arrangement, in another embodiment, those reacting chambers can be arranged in the cluster type or other type, such as shown in FIG. 4, those reacting chambers 340 are arranged in the cluster type. Moreover, refer to FIG. 3A, the transportation device 230, the cooling device 250 and the reacting chamber 240 are arranged in a closed space; and the closed space are cycle purged with nitrogen gas. In another embodiment, referring to FIG. 3B, the transportation device 230 are arranged in a closed space; the cooling device 250 has a gate valve 252; the chamber gate valve 242 and the gate valve 252 are connected with the closed space; and the closed space are cycle purged with nitrogen gas. FIG. 4, in the embodiment, the transportation device 330 is arranged in a closed space and the cooling device 350 has a gate valve, such as gate valve 352. As shown in the figure, the chamber gate valve 342 and the gate valve 352 are connected with the closed space and the closed space is cycle purged with nitrogen gas too. Furthermore, as shown in FIG. 3A, FIG. 3B and FIG. 4, the stacked cassette 210, 310 has two cassette gate valves 214, 216, 314, 316; one of the cassette gate valves, such as cassette gate valves 214 and 314, face to the closed space; another cassette gate valve, such as cassette gate valves 216 and 316, face to an external atmospheric environment; and the stacked cassette 210, 310 are cycle purged with nitrogen gas.

In another embodiment, an epitaxy processing method is provided herein including the following step. First, providing a plurality of susceptors disposed in a stacked cassette, wherein each of those susceptors has at least a wafer placed thereon. Next, transporting the susceptor by a transportation device from the stacked cassette into a reacting chamber having a chamber gate valve, the susceptor is transported while the chamber gate valve is open and the wafer is processed while the chamber gate valve is closed. And then, transporting the processed wafer by the transportation device from the reacting chamber under a high temperature into a cooling device. Next, cooling the processed wafer to a lower temperature by the cooling device. Finally, after transporting the processed wafer into the cooling device, transporting another susceptor from the staked cassette into the reacting chamber by the transportation device for next run processing.

Continuing the above description, in one embodiment, the cooling method includes an upper gas sparging purging cooling method, an underneath fluid pipe conduction cooling method or a superconductor medium contact cooling method. Besides, in another embodiment, the high temperature is over 500° C., and the lower temperature is below 150° C. The epitaxy processing method can be utilized to sequentially cool down those susceptors respectively from each reacting chamber which remains substantially at the high temperature after reacting so that the production output of the system can be improved.

Continuously, in the above-mentioned embodiments, those reacting chambers can co-use at least one cooling device to cool down the susceptors and the wafers placed thereon under high temperature to provide a maximum temperature-lowering function and increase the production capacity. Besides, the function and recipe of those reacting chambers can be different. Moreover, when the number of the reacting chambers is increased to a specific amount, another cooling device can be added to the system.

To sum up the foregoing descriptions, the present invention generally provides an epitaxy processing system and processing method including a reacting chamber, a transportation device which provides the susceptor transportation and a cooling device which provides a quickly temperature-lowering function and a volume minimized stacked cassette as a loadlock function.

The foregoing descriptions of specific embodiments of the present invention have been presented for purposes of illustrations and description. They are not intended to be exclusive or to limit the invention to the precise forms disclosed, and obviously many modifications and variations are possible in light of the above teaching. The embodiments were chosen and described in order to best explain the principles of the invention and its practical application, to thereby enable others skilled in the an to best utilize the invention and various embodiments with various modifications as are suited to particular use contemplated. It is intended that the scope of the invention be defined by the claims appended hereto and their equivalents.

1. An epitaxy processing system comprising:
a stacked cassette comprising a plurality of susceptors, wherein each of said susceptors has at least a wafer placed thereon;
a transportation device, for transporting said susceptors and said wafer thereon;
a reaction chamber having a chamber gate valve, wherein said susceptor comprising said wafer thereon are transported by said transportation device from said stacked cassette while said chamber gate valve is open and said wafer is processed while said chamber gate valve is closed; and
a cooling device, for cooling said susceptor and said processed wafer thereon transported by said transportation device from said reaction chamber under a high temperature, and said susceptor and said processed wafer are cooled down to a lower temperature, after transporting said susceptor and said processed wafer into said cooling device, said transportation device transports another said susceptor having said wafer placed thereon from said staked cassette into said reaction chamber.

2. The epitaxy processing system according to claim 1, wherein said transportation device, said cooling device and said reaction chamber are arranged in a closed space which is called a glove box and said glove box is purged with nitrogen gas.

3. The epitaxy processing system according to claim 2, wherein said stacked cassette has two cassette gate valves; one of said cassette gate valves faces to said glove box; another said cassette gate valve faces to an external atmospheric environment; and said stacked cassette is purged with nitrogen gas.

4. The epitaxy processing system according to claim 1, wherein said transportation device, said cooling device and said chamber gate valve of said reaction chamber are arranged in a closed space which is called a glove box and said glove box is purged with nitrogen gas.

5. The epitaxy processing system according to claim 4, wherein said stacked cassette has two cassette gate valves; one of said cassette gate valves faces to said glove box; another said cassette gate valve faces to an external atmospheric environment; and said stacked cassette is purged with nitrogen gas.

6. The epitaxy processing system according to claim 1, wherein said transportation device comprises a robot or a linear slide guide.

7. The epitaxy processing system according to claim 1, wherein said susceptor comprises pi-shaped profile, and said susceptor comprises:
a plate comprising at least said wafer placed thereon;
a ring-like flange, forming a peripheral extension of said plate, for detachably contacting with said transportation device; and
an encircled supporting wall underneath said plate, an inner side of said supporting wall is beveled outwardly, a beveled edge is inclined so that there is an obtuse angle between said plate and the inner side of said supporting wall, in order to mount on said cooling device.

8. The epitaxy processing system according to claim 1, wherein said cooling device utilizes an upper gas sparging purging cooling method, a underneath fluid pipe conduction cooling method or a superconductor medium contact cooling method.

9. The epitaxy processing system according to claim 1, wherein said high temperature is over 500 degree Celsius, and said lower temperature is below 150 degree Celsius.

10. The epitaxy processing system according to claim 1, wherein said reaction chamber remains substantially at the high temperature when receiving another said susceptor and said wafer.

11. An epitaxy processing system, comprising:
a stacked cassette comprising a plurality of susceptors, wherein each of said susceptors comprises at least a wafer placed thereon;
a transportation device for transporting said susceptors with said wafer thereon;
a plurality of reaction chambers arranged around said transportation device, each of said reaction chambers having a chamber gate valve, wherein said susceptors having said wafer placed thereon are respectively transported by said transportation device from said stacked cassette to said reaction chambers; and for each of said reaction chambers, said susceptor and said wafer thereon are transported while said chamber gate valve is open, and said wafer is processed while said chamber gate valve is closed; and
a cooling device for sequentially cooling said susceptor and said processed wafers thereon transported by said transportation device respectively from said reaction chambers under a high temperature, and said susceptor and said processed wafers are respectively cooled down to a lower temperature, wherein said cooled susceptor and said cooled processed wafers are removed out of said cooling device by said transportation device to load in said stacked cassette, once said susceptor and said wafer are removed out from said reaction chamber, another said susceptor with said wafer placed thereon is transported from said stacked cassette to said empty reaction chamber by said transportation device.

12. The epitaxy processing system according to claim 11, wherein said reaction chambers are arranged in an in-line type or a cluster type arrangement.

13. The epitaxy processing system according to claim 11, wherein said transportation device, said cooling device and said reaction chamber are arranged in a closed space; and said closed space is purged with nitrogen gas.

14. The epitaxy processing system according to claim 13, wherein said stacked cassette has two cassette gate valves; one of said cassette gate valves faces to said closed space; another said cassette gate valve faces to an external atmospheric environment; and said stacked cassette is purged with nitrogen gas.

15. The epitaxy processing system according to claim 11, wherein said cooling device has a gate valve; said gate valve, said chamber gate valve, and said transportation device are arranged in a closed space; and said closed space is purged with nitrogen gas.

16. The epitaxy processing system according to claim 15, wherein said stacked cassette has two cassette gate valves; one of said cassette gate valves faces to said closed space; another said cassette gate valve faces to an external atmospheric environment; and said stacked cassette is purged with nitrogen gas.

17. The epitaxy processing system according to claim 11, wherein said transportation device has a linear slide guide system and a robot set on said linear slide guide system.

18. The epitaxy processing system according to claim 11, wherein said susceptor has pi-shaped profile, and said susceptor comprises:
a plate comprising a wafer placed thereon;
a ring-like flange, forming a peripheral extension of said plate, for detachably contact with said transportation device; and
an encircled supporting wall underneath said plate, an inner side of said supporting wall is beveled outwardly, a beveled edge is inclined so that there is an obtuse angle between said plate and the inner side of said supporting wall, in order to mount on said cooling device.

19. The epitaxy processing system according to claim 11, wherein said cooling device utilizes a upper gas sparging cooling method, a lower fluid conduction pipe cooling method or a superconductor medium contact cooling method.

20. The epitaxy processing system according to claim 11, wherein said high temperature is over 500 degree Celsius, and said lower temperature is below 150 degree Celsius.

21. The epitaxy processing system according to claim 11, wherein said reaction chamber remains substantially at the high temperature when receiving another said susceptor and said wafer thereon.

22. An epitaxy processing method comprising:
providing a plurality of susceptors disposed in a stacked cassette, wherein each of said susceptors comprises at least a wafer placed thereon;
transporting said susceptor and said wafer from said stacked cassette into a reaction chamber having a chamber gate valve by using a transportation device, wherein said susceptor and said wafer are transported while said chamber gate valve is open and said wafer is processed while said chamber gate valve is closed;
transporting said susceptor and said processed wafer from said reaction chamber under a high temperature into a cooling device using said transportation device;
cooling said susceptor and said processed wafer to a lower temperature by said cooling device; and
after transporting said susceptor and said processed wafer into said cooling device, transporting another said susceptor with said wafer placed thereon from said staked cassette into said reaction chamber by using said transportation device for next run processing.

23. The epitaxy processing method according to claim 22, wherein the method for cooling said processed wafer comprises an upper gas sparging purging cooling method, an underneath fluid pipe conduction cooling method or a superconductor medium contact cooling method.

24. The epitaxy processing method according to claim 22, wherein said high temperature is over 500 degree Celsius, and said lower temperature is below 150 degree Celsius.
